(19) United States
(12) Patent Application Publication
(10) Pub. No.: US 2004/0160430 A1
(43) Pub. Date: Aug. 19, 2004

(54) Data input system

(76) Inventors: Minoru Tokunaga, Yokohama (JP); Kenji Fujii, Kawasaki (JP); Masatoshi Furuya, Sagamihara (JP); Takumi Hayashi, Chiba (JP)

Correspondence Address: Mattingly, Stanger & Malur, P.C, Suite 370, 1800 Diagonal Road, Alexandria, VA, 22314, US

(21) Appl. No.: 10/641,053

(22) Filed: Aug. 15, 2003

(30) Foreign Application Priority Data
Feb. 12, 2003 (JP) 2003-033093

(51) Int. Cl. G09G 5/00

(52) U.S. Cl. 345/179

(57) ABSTRACT

In an electronic pen system where it is required to identify each sheet of paper having an identical dot pattern, a document for inputting an identification code is prepared, where a code obtained by conversion according to a position of dot pattern is predetermined, and according to a combination of a plurality of codes determined based on the contents entered in the document, a type of the document is identified.

### BACKGROUND OF THE INVENTION

1. Field of the Invention

The present invention relates to a system utilizing an electronic pen, which digitalizes locus data such as characters and graphics being hand-written in paper and inputs thus digitalized data into an information processing unit.

2. Description of the Related Art

An electronic pen, which allows hand-written data such as characters and graphics to be digitalized and brought into a personal computer, word processor and the like, has been developed and put into practical use. As a pen technique having such a function as digitalizing hand-written character/graphics data and transmitting to predetermined equipment, there is an art described in the document of WO 01/26033 A1, for example. In this kind of art, by using a special electronic pen and paper, a locus of character/graphics written in paper using an electronic pen is subjected to vector conversion, and thus converted data can be stored and transmitted.

Referring to FIG. 2, the above mechanism will be explained briefly. A dot pattern 210 is printed on paper 102. Dots are printed on a grid having grid points at regular intervals, and the dots are respectively positioned subtly off the grid points. A built-in camera 203 in an electronic pen 101 reads the dot pattern 210, and it is possible to precisely identify absolute coordinates where the pen tip of the electronic pen 101 is located within the dot pattern space.

The electronic pen 101 incorporates the camera 203, an ink cartridge 204, a pen pressure sensor 205, a processor 206, a memory 207, a battery 208, and a communication unit 209. Only when the pen pressure sensor 205 senses a pressure, the camera 203 reads the dot pattern, and the processor 206 obtains positional information of the pen tip. In other words, a locus of character and/or graphics, which has been handwritten in the paper 102, is obtained in digitalized form. The digitalized locus information is accumulated in the memory 207 in chronological order, and at certain timing, it is transmitted to predetermined equipment by the communication unit 209.

In the meantime, if the printed dot pattern is different for each sheet of paper, it is possible to identify in which paper the data entry has been made, according to the absolute coordinates of the digitalized data. However, it may cause an increase of printing cost and exhaustion of dot pattern space, in the case where an enormous volume of paper is used and different dot patterns are printed respectively on all the paper.

Accordingly, an identical dot pattern should be used for plural sheets of paper. In this case however, there is a problem that it is out of recognition in which paper the data entry has been made.

As a method for solving the above problem, there is an art as described in the document of WO 01/75779 A1. In this art, a particular region is secured in a part of paper, and boxes are printed within that region. The boxes are printed in positions that are different by every sheet of paper, and marked by use of an electronic pen. Based on the positional information of the marked data, each sheet of paper is identified.

Typically, in a system utilizing a document, data is inputted from various documents written on an individual basis. In order to allow an information processing unit to conduct an identification process on such various hand-written data, it is necessary to prepare a large amount of numbers to identify each document. In the above prior art, it is required, before starting operation of the electronic pen system, to decide relations between arrangements of boxes to be printed on the entire large volume of paper and identification codes for identifying the documents, respectively, and the system should be prepared for controlling thus decided relations.

Furthermore, in order to identify the documents on an individual basis, it is necessary to print on each sheet, arrangements of boxes different by sheet, even if the volume of paper is enormously large. Therefore, printing cost is increased.

Furthermore, since the box printing region is to be within a restricted area, there is a limit in arranging the boxes. In addition, even if a certain number of box arrangement types can be secured, initially required at the time of operation starting, it may be difficult to handle a case where the number of paper sheets to be identified goes beyond the initial number, in the course of the operation.

Furthermore, it is also difficult to handle the case where the positional information of the boxes becomes unreadable during the operation, when the box printing region is smudged or torn, or a same box is repeatedly marked.

Furthermore, when a misalignment in printing on the dot pattern is large, identification of the paper becomes hard, since each sheet is identified by use of the positional information. Printing with a smaller misalignment increases the printing cost.

### SUMMARY OF THE INVENTION

An objective of the present invention is to provide a data input system, where it is possible to identify in which paper a data entry has been made, out of plural sheets of paper having an identical dot pattern.

In order to achieve the above objective, the present invention provides a system utilizing an electronic pen for reading a dot pattern and for digitalizing contents written in paper, comprising a means for holding a correspondence between a first dot pattern area and a first document layout, a means for holding a correspondence between a second dot pattern area and a second document layout, a means for holding a correspondence between a position decided by the dot pattern in the second dot pattern area, and a code for conversion as to the position thus decided, a means for identifying the first document layout according to a combination of codes inputted in the second document, and a means for holding data entered in the first document, in such a manner as being associated with thus identified document layout.

### BRIEF DESCRIPTION OF THE DRAWINGS

FIG. 1 is a system block diagram, showing one embodiment of a schedule management system according to the present invention;

FIG. 2 is a block diagram of an electronic pen used in the schedule management system;

FIG. 3 is an illustration showing a structure of layout definition table;

FIG. 4 is an illustration showing a structure of meaning definition table;

FIG. 5 is an illustration showing a structure of use purpose definition table;

FIG. 6 is an illustration showing a structure of schedule management table;

FIG. 7 is a flowchart showing a processing procedure of the system;

FIG. 8 is an illustration showing a document layout used in the schedule management system;

FIG. 9 is an illustration showing a relation between a layout and a dot pattern absolute coordinate space;

FIG. 10 is an illustration showing documents used in the schedule management system;

FIG. 11 is an illustration showing an example of entry in the paper, used in the schedule management system; and

FIG. 12 is an illustration showing a relation between digitalized data (coordinate string data) of contents entered in the paper and the dot pattern absolute coordinate space.

### DETAILED DESCRIPTION OF THE PREFERRED EMBODIMENTS

Preferred embodiments of the present invention will be described in detail with reference to the attached drawings. The present embodiment relates to a schedule management system, which is used in a business organization, where one person in charge digitalizes schedules of a plurality of employees by use of an electronic pen system, and manages the digitalized schedule.

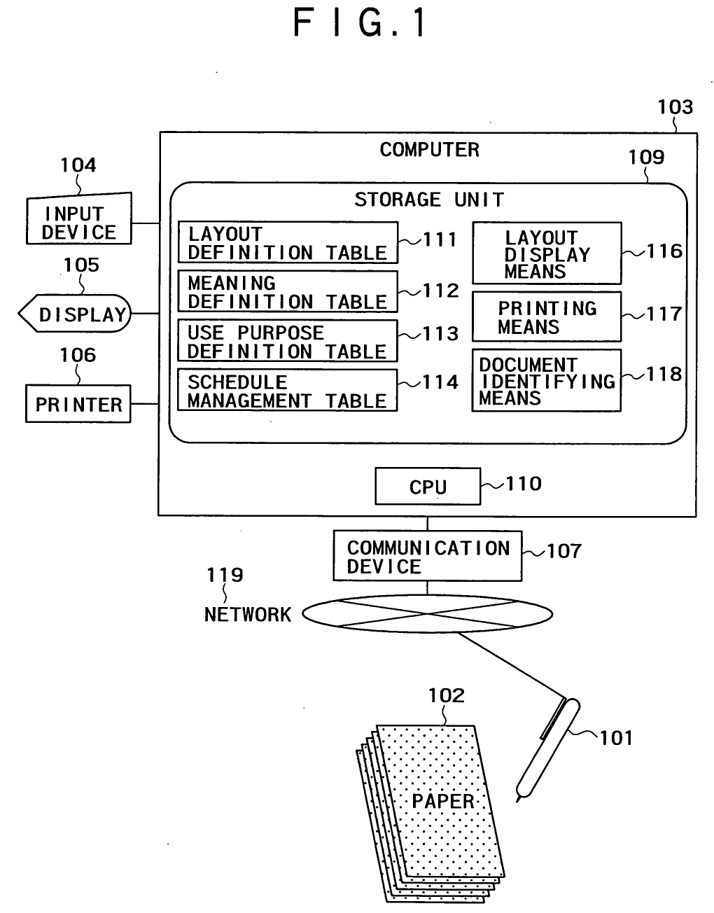

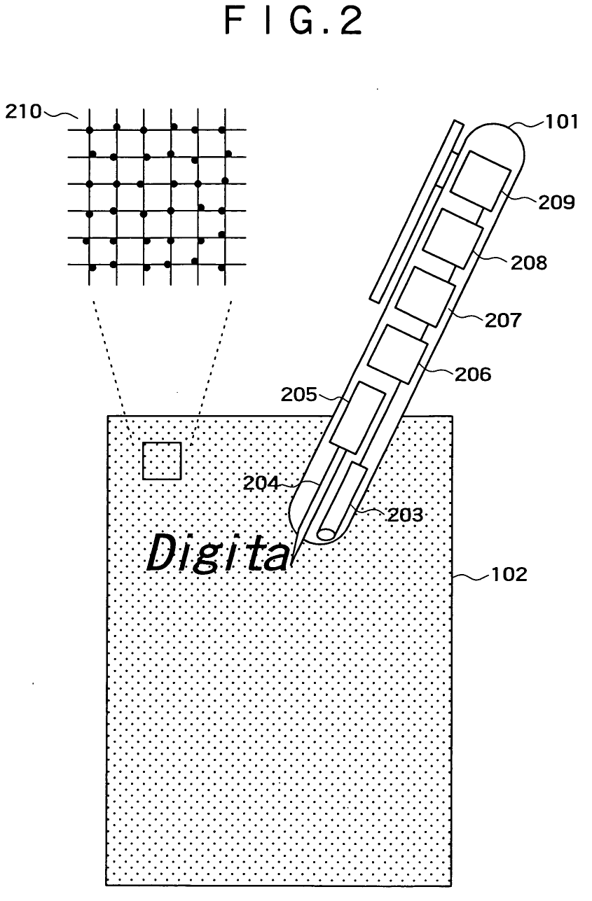

FIG. 1 shows an entire system configuration for implementing the present embodiment. The schedule management system 108 comprises a computer 103 connecting to an input device 104, a display 105, a printer 106, and a communication device 107, an electronic pen 101, paper 102, and a network 119. The network 119 is a network configured by a public mobile communication network, a public fixed communication network, the Internet, wireless/wired LAN, and the like. The input device 104 is a keyboard, a mouse and the like to perform inputting to the computer 103. The display 105 is a display for displaying processed and stored information and/or layouts information and the like in the computer 103. The printer 106 is a printing device for performing a predetermined printing onto a sheet of paper set as printing paper. The communication device 107 is a device for receiving the digitalized data transmitted from the electronic pen 101 via the network 119. The computer 103 may be incorporated in the electronic pen 101.

The computer 103 comprises a CPU 110 and a storage unit 109. In the storage unit 109, there are held three processing means 116 to 118, which are programs playing a role as individual processing means by sequentially read in and executed by the CPU 110, and four tables 111 to 114.

A table structure of the schedule management table 114 is shown in FIG. 6. The schedule management table 114 holds data entered in the document by employee and by date in year/month, and includes columns of “Employee ID”, “Date in year/month” and “Coordinate string data”. The “Employee ID” is a number predetermined uniquely by employee, having four digits. The “Date in year/month” is a string of numbers having six digits, i.e., four digits of the Christian Era year and two digits of month. The “Coordinate string data” is data entered in the document, which has been digitalized by the electronic pen system employed in the present system.

A table structure of the layout definition table 111 is shown in FIG. 3. The layout definition table 111 holds correspondences between all the layouts that are utilized by being printed on paper, and dot patterns of the paper on which the layouts are printed. This table includes columns of “Dot pattern” and “Layout”.

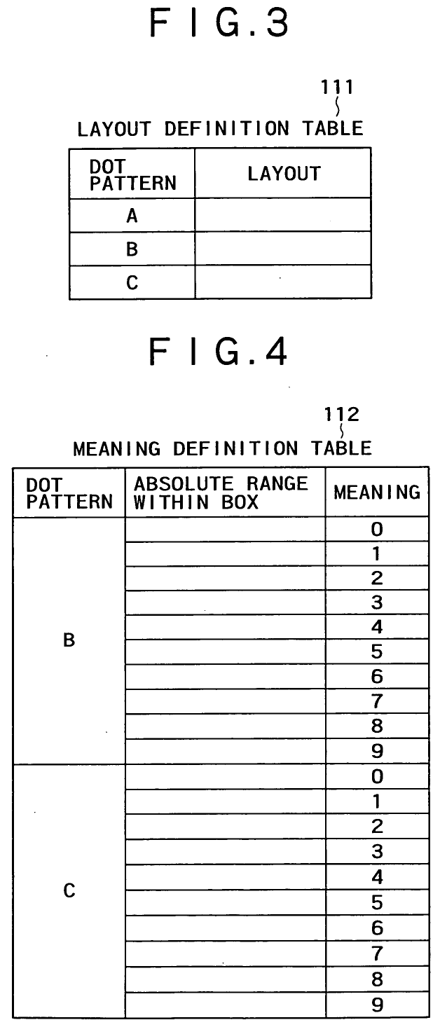

A table structure of the meaning definition table 112 is shown in FIG. 4. The meaning definition table 112 holds, by dot pattern, correspondences between absolute coordinate ranges within each box printed on paper having the dot pattern, and meanings. This table includes columns of “Dot pattern”, “Absolute coordinate range within a box” and “Meaning”. The “Absolute coordinate range within a box” corresponds to a range of coordinates within an internal region of each box, on the dot pattern absolute coordinate space in the electronic pen system employed in the present system.

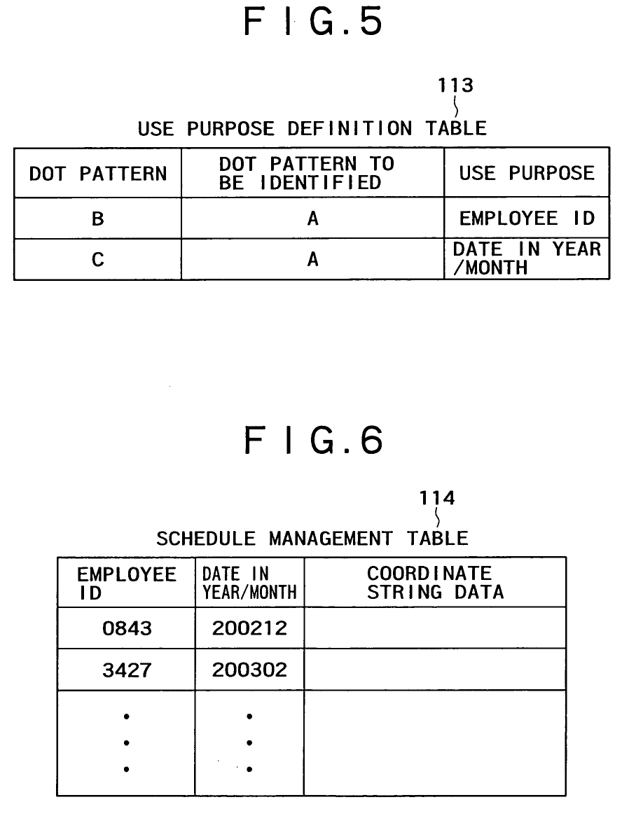

A table structure of the use purpose definition table 113 is shown in FIG. 5. The use purpose definition table 113 holds following definitions by dot pattern: what is a target dot pattern printed on another document to be identified by utilizing each dot pattern, and for what use purpose the meaning held in the meaning definition table 112 is used. Therefore, the table includes columns of “Dot pattern”, “Dot pattern to be identified” and “Use purpose”.

The layout display means 116 displays an available layout on the display 105. The printing means 117 receives an input via the input device 104 from the person in charge, such as a layout and the number of sheets required to be printed out, and executes printing by use of the printer 106 on the paper set thereon. The document identifying means 118 receives the digitalized data transmitted from the electronic pen 101 held by the person in charge, via the communication device 107, and identifies in which paper the transmitted digital data has been entered.

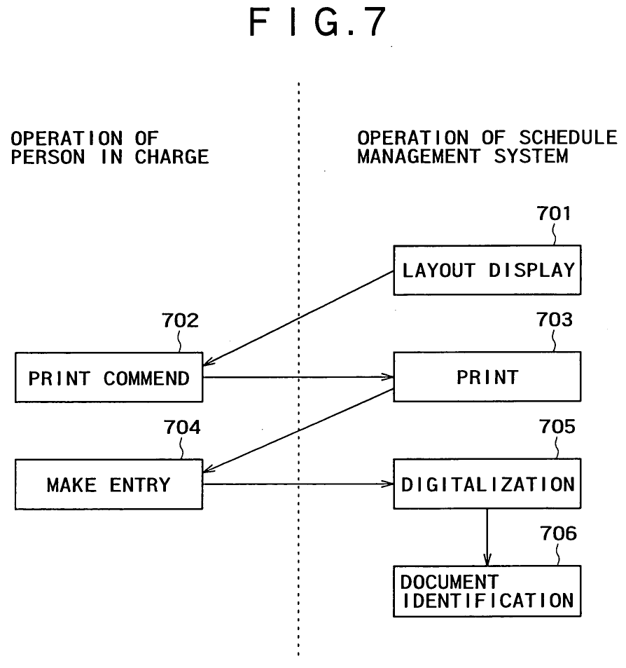

In the present embodiment, by operating the schedule management system 108 adequately, it has been implemented that each of plural sheets of paper having an identical dot pattern is identified. Hereinafter, this operation will be explained with reference to FIG. 7.

(1) Layout Display 701

In layout display means 116 in the computer 103, all the “Layouts” stored in the layout definition table 111 are displayed on the display 105.

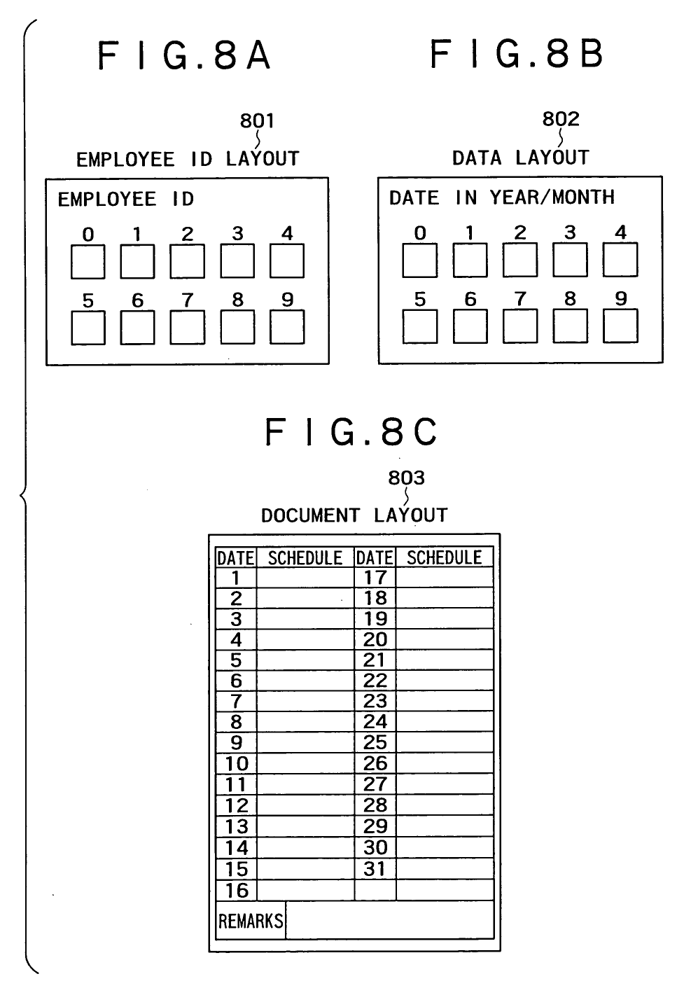

Here, as a way of example, layouts as shown in FIG. 8 A-8 C are employed. Document layout 803 is a layout of a document to be entered by a person in charge, with schedule for each employee and for each date in year/month. This layout is used for all the employees and for all the dates of year/month. Employee ID layout 801 is a layout for specifying an employee ID of an employee whom the schedule to be entered belongs to. The date layout 802 is a layout for specifying a date in year/month when the schedule to be entered belongs to. As shown in FIG. 8 A, 8 B, both in the employee ID layout 801 and the date layout 802 include 10 (ten) boxes to which numbers having own meanings are provided respectively. It may be possible to place the numbers within the boxes respectively. In any case, it is sufficient if each meaning of the boxes can be recognized.

It is preset in the layout definition table 111 which dot pattern is used for each layout. Here, dot pattern A is used for the document layout 803, dot pattern B is used for the employee ID layout 801, and dot pattern C is used for the date layout 802.

As described above, the paper having the dot pattern B is utilized to identify an employee ID of the data entered in the paper having the dot pattern A. The paper having the dot pattern C is utilized to identify a date in year/month of the data entered in the paper having the dot pattern A. The related information is set in the use purpose definition table 113.

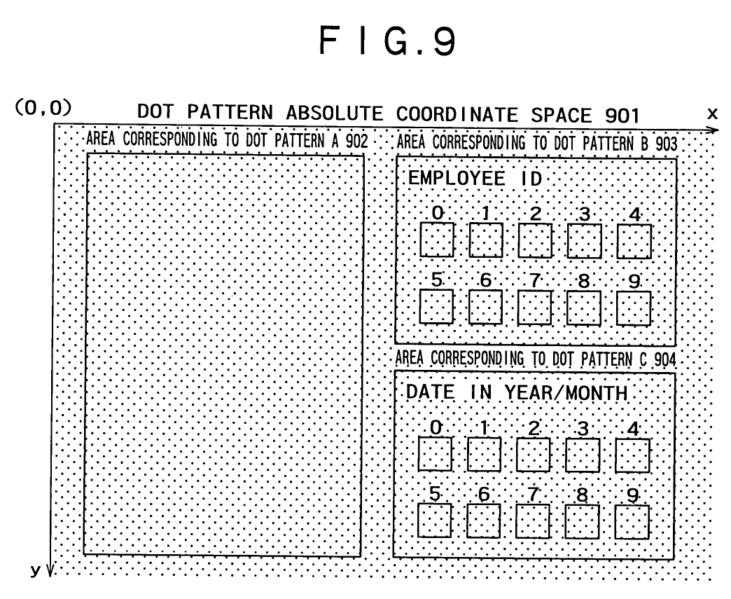

Furthermore, meanings of each box both in the employee ID layout 801 and the date layout 802 are preset in the meaning definition table 112. In FIG. 9, there is shown a dot pattern absolute coordinate space 901 in the electronic pen system employed in the present system. In the dot pattern absolute coordinate space 901, an area 902 corresponding to the dot pattern A, an area 903 corresponding to the dot pattern B and an area 904 corresponding to the dot pattern C are as shown in FIG. 9. According to a correspondence between “Layout” and “Dot pattern” in the layout definition table 111, boxes are respectively converted to coordinate ranges on the dot pattern absolute coordinate space 901. Then, they are defined in the meaning definition table in such a manner as being associated with meanings of the box within the coordinate ranges, respectively. For example, setting is made in the meaning definition table 112 such that in the area 903 corresponding to the dot pattern B, the box indicating “1” in the employee ID layout is converted to a coordinate range on the dot pattern absolute coordinate space 901, deciding that thus converted coordinate range indicates the number “1”.

(2) Print Command 702

The person in charge selects a layout to be printed out from the displayed layout list as described above, and inputs via the input device 104 the selected layout and desired number of sheets. In addition, since a dot pattern corresponding to the selected layout is displayed on the display 105, paper having the dot pattern is set in the printer 106.

As a way of example here, sheets of paper having the dot pattern A are set in the printer 106, and an input is made via the input device 104, including a command that a document layout 803 is selected and a large number of sheets is to be printed out. Alternatively, it may be possible to set blank sheets without any dot patterns in the printer 106.

(3) Print 703

In the printing means 117 in the computer 103, based on the input as described above, the selected layout is printed by the printer 106 on the paper set therein for specified number of sheets, with reference to the layout definition table 111.

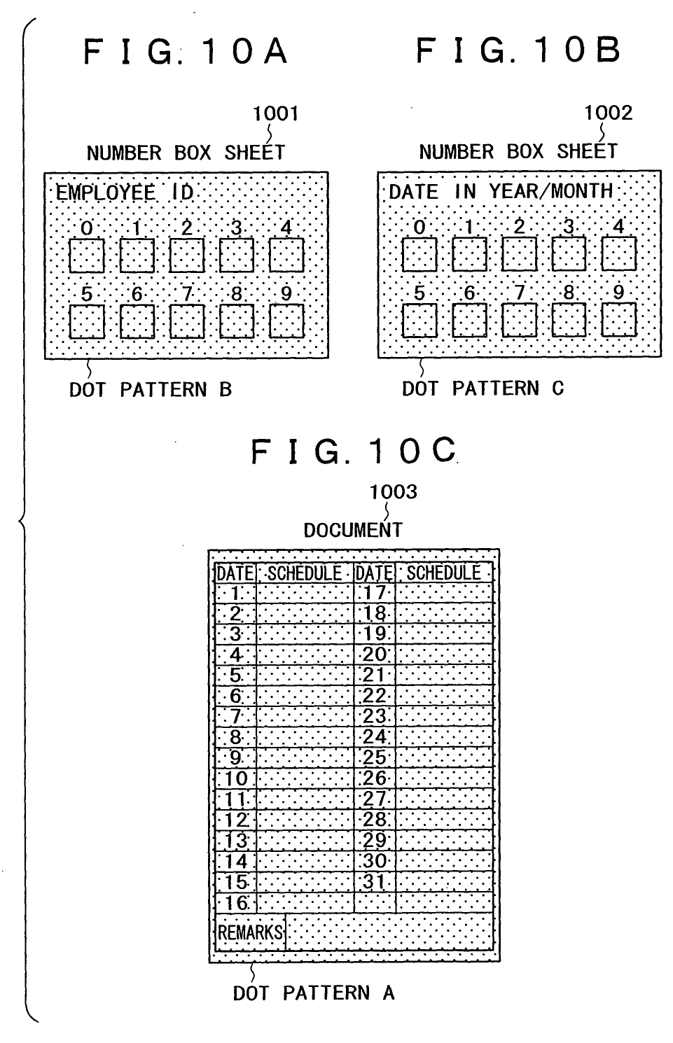

As a way of example here, the document layout 803 is printed on the sheet of paper having the dot pattern A, for a large number of sheets. The paper thus printed out is a document 1003 as shown in FIG. 10 B. If a blank sheet without any dot patterns is set in the printer 106 in the above step (2) print command 702, it may also be possible to simultaneously print the dot pattern A and the document layout 803 on the blank sheet.

Subsequently, when another layout is printed out, the above step (2) print command 702 and this step (3) print 703 are repeated. As a way of example here, the employee ID layout 801 is printed on one sheet of paper having dot pattern B (a sheet physically separated from the sheet having the dot pattern A). The sheet of paper thus printed is a number box sheet 1001, as shown in FIG. 10 A. Furthermore, the date layout 802 is printed on one sheet of paper having dot pattern C (a sheet physically separated from the sheet having the dot pattern A and the sheet having the dot pattern B). The sheet of paper thus printed is a number box sheet 1002, as shown in FIG. 10 B.

(4) Make an Entry 704

The person in charge uses one electronic pen 101, for checking an employee ID in the number box sheet 1001 and a date in year/month in the number box sheet 1002, and in the document 1003, making an entry of schedule corresponding to the checked employee ID and the date.

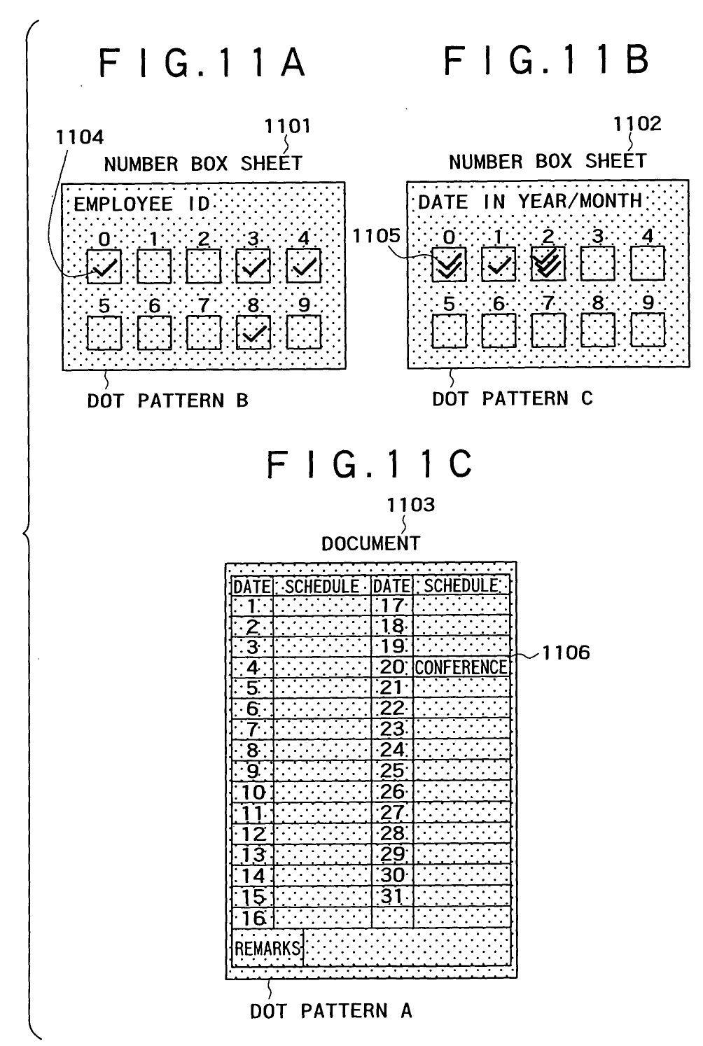

For example, when a schedule is to be entered as to an employee having the employee ID “0843” for the date of “December 2002”, before entering the schedule in the document 1003, a box indicating “0”, a box indicating “8”, a box indicating “4”, and a box indicating “3” in the number box sheet 1001 are checked in this sequence. Then, box indicating “2”, a box indicating “0”, a box indicating “0”, a box indicating “2”, a box indicating “1”, and a box indicating “2”, in the number box sheet 1002 are checked in this sequence. It does not matter which is checked first, the number box sheet 1001 or the number box sheet 1002. Subsequently, the schedule is entered in the document 1003. A resulted image is shown in FIG. 11 A-11 C. A number box sheet 1101, a number box sheet 1102, and a document 1103 respectively represent that the number box sheet 1001, the number box sheet 1002, and the document 1003 include entries of 1104, 1105 and 1106.

Subsequently, when a schedule is to be entered as to an employee having the employee ID “3427” for the date of “February 2003”, a box indicating “3”, a box indicating “4”, a box indicating “2”, and a box indicating “7” in the number box sheet 1001 are checked in this sequence. Then, box indicating “2”, a box indicating “0”, a box indicating “0”, a box indicating “3”, a box indicating “0”, and a box indicating “2”, in the number box sheet 1002 are checked in this sequence. Then, the schedule is entered in the document 1003.

(5) Digitalization 705

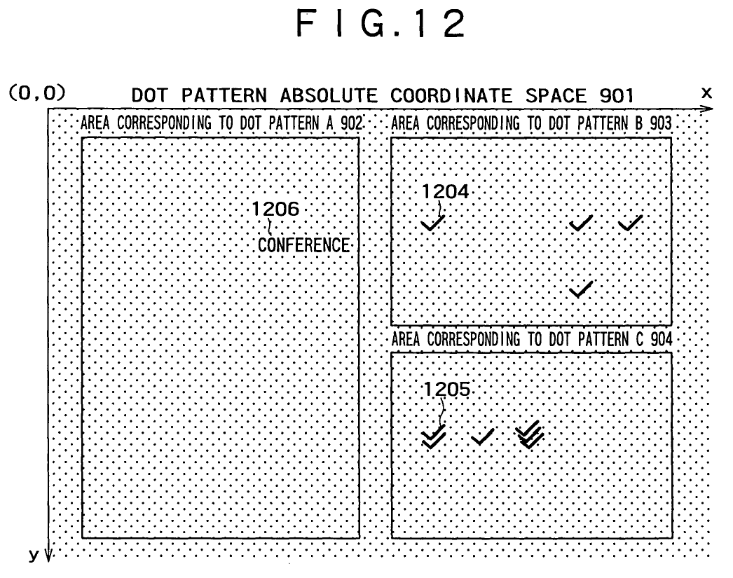

In the above step (4) Make an entry 704, a camera 203 of the electronic pen 101 reads the dot patterns printed in the number box sheet 1001, the number box sheet 1002 and the document 1003, only when the pen pressure sensor 205 senses a pressure. Then, the processor 206 obtains positional information of the pen tip in the sequence of entries, and stores the positional information in the memory 207. In other words, the contents of entries 1104, 1105 and 1106 are respectively digitalized as coordinate string data items 1204, 1205 and 1206 on the dot pattern absolute coordinate space 901 as shown in FIG. 12, and the digitalized data is recorded in the memory 207.

Subsequently, the digitalized data recorded in the memory 207 is transmitted from the communication unit 209 to the communication device 107 via the network 119.

(6) Document Identification 706

In the document identifying means 118 in the computer 103, the digitalized data transmitted from the electronic pen 101 is received by the communication device 107. The digitalized data thus received is obtained in the sequence of entries. Then, according to the relation between the dot pattern shown on the dot pattern absolute coordinate space 901 and the corresponding area, as shown in FIG. 12, it is determined, based on the absolute coordinate value of the digitalized data, which dot pattern is held by the sheet of paper where the data has been entered. Referring to the meaning definition table 112, if the above dot pattern is defined in the column of “Dot pattern”, the digitalized data is converted to the “Meaning” corresponding to the “Absolute coordinate range within a box” that includes the absolute coordinate value of the digitalized data.

Furthermore, referring to the use purpose definition table 113, if the above dot pattern is defined in the column of “Dot pattern”, a corresponding “Use purpose” is recorded on the schedule management table 114 with the “Meaning” that has been obtained above. Subsequently, when digitalized data of the “Dot pattern to be identified” corresponding to the above dot pattern is obtained, a series of the digitalized data (before digitalized data of other dot pattern appears) is recorded as the “Coordinate string data” corresponding to the use purpose of the schedule management table 114 as described above.

More specifically, the coordinate string data 1206 can be obtained after the coordinate string data items 1204, 1205 are obtained. Then, it is determined that a dot pattern to which the coordinate string data 1204 corresponds is dot pattern B, and a dot pattern to which the coordinate string data 1205 corresponds is dot pattern C. Referring to the meaning definition table 112, the coordinate string data 1204 is converted to “0”, “8”, “4”, and “3”, sequentially, i.e., “0843”, and the coordinate string data 1205 is converted to “2”, “0”, “0”, “2”, “1” and “2”, sequentially, i.e., “200212”. Furthermore, referring to the use purpose definition table 113, “0843” is recorded as “Employee ID” and “200212” is recorded as “Date in year/month” in the schedule management table 114. Subsequently, it is determined that the dot pattern to which the coordinate string data 1206 corresponds is dot pattern A, and then, the coordinate string data 1206 is recorded as “Coordinate string data” of the schedule management table 114.

With the process as described above, it is possible to identify in which document (who is the employee and what date) the received digitalized data has been entered.

As described above, in the present invention, it is possible to identify each of plural sheets of paper having an identical dot pattern, by operating adequately the schedule management system 108. In this case, it is not necessary to preset for entire enormous volume of paper, special layouts for document identifying input (arrangement of boxes, bar code, and the like), nor to provide the schedule management system 108 with a table for managing a correspondence between a special layout for document identifying input and the document itself. In other words, the “Meaning” itself (numbers in the above example) converted from the coordinate string data can be used as “Employee ID” and “Date in year/month” of the schedule management table 114, which are keys for identifying a document in the schedule management system 108.

It is further possible to suppress printing cost since it is not necessary to print the special layout for the document identifying input (e.g., arrangement of different boxes) for entire enormous volume of paper. In addition, there is no restriction in numbers, such as identifiable number of sheets, that restriction having been caused by a limit in the number of boxes and positions thereof and/or a limit in bar cord numbers. Therefore, even when the number of sheets to be identified goes beyond an expected identifiable number in the course of system operation, it is easily handled. For example, when the employee ID is changed to 5 digits from 4 digits, it is not necessary to conduct reprinting to make a new box.

It is also easy to handle the case where the box positional information becomes unreadable, when the box printing region is smudged or torn, or a same box is repeatedly marked. For example, in such a case, changing the number box sheet is sufficient. Alternatively, the number box sheet may be made of durable paper. In addition, since the area of the box printing region does not affect the document layout, there is not a large restriction in number and size of the box. Therefore, it is possible to decrease constraint in the identifiable number of sheets, and also misalignment in printing has little impact. Being resistant to the misalignment in printing, a high level printing method is not necessary, and printing cost can be suppressed. Even in the case where the area of the number box sheet is not sufficiently large to cope with the misalignment in printing, only the number box sheet requires a high level printing method, and thus printing cost can be cut down comparing to printing enormous volume of document sheets.

In the above embodiment, two types of number box sheets having different dot patterns are used. Alternatively, the number box sheet can be one type, or plural types of number box sheets having different dot patterns can be used.

Further, in the above embodiment, boxes each having a meaning are printed on a sheet physically separated from the document to be identified. Alternatively, such a box having a meaning can be printed on a same sheet as the document to be identified. In this case, in the use purpose definition table 113, a same dot pattern is defined in the columns of “Dot pattern” and “Dot pattern to be identified”. Further, “a series of digitalized data” in the step of (6) Document identification 706, indicates digitalized data before the digitalized data having another dot pattern appears, or before the digitalized data within another “Absolute coordinate range within a box” in the meaning definition table 112 appears.

Furthermore, in the above embodiment, the document layout to be identified is just one type. Alternatively, the number box sheet can be used to identify a plurality of types of documents having different layouts. Moreover, in the above embodiment, boxes are printed on the number box sheet, as a mark having a meaning. Alternatively, a line or a number itself may be printed as a mark instead of the box. Further, in the above embodiment, a number is used to give a meaning to the box, but alternatively, a character or a symbol may be used.

According to the present invention, in the electronic pen system where a dot pattern printed on paper is read by an electronic pen, and characters/graphics hand-written on paper is digitalized, it is possible to save labor of advance setting, when it is required to identify in which paper a data entry has been made, out of a plurality of sheets of paper having a same dot pattern.

What is claimed is:

1. A data input system in a system utilizing an electronic pen for reading a dot pattern and digitalizing contents written in paper, comprising:
means for holding a correspondence between a first area of the dot pattern, and a first document layout,
means for holding a correspondence between a second area of the dot pattern, and a second document layout having a plurality of marks arranged in positions given in advance,
means for holding a correspondence between said plurality of marks and codes for conversion respectively determined for the positions of the marks, and
means for holding data entered in said first document layout in such a manner as being associated with a combination of the codes, which have been converted based on inputs in the marks in said second document layout.

2. A data input system according to claim 1, wherein,
said first document layout and said second document layout are printed on physically separated sheets of paper, respectively, so as to be used as data input forms.

3. A data input system according to claim 1, wherein, said marks are boxes.

4. A data input system according to claim 2, wherein, said marks are boxes.

5. A data input system according to claim 1, wherein, said codes are numbers.

6. A data input system according to claim 2, wherein, said codes are numbers.

7. A data input system according to claim 3, wherein, said codes are numbers.

8. A data input system according to claim 4, wherein, said codes are numbers.

9. A data input system, wherein,
a box sheet and a document having different dot patterns respectively are printed out,
positional information of the pen tip of an electronic pen is obtained, according to the dot patterns of a mark in a box shown in said box sheet and information in said document, the mark and the information having been entered by said electronic pen,
said positional information is converted to digital data and is transmitted to a computer,
said computer makes a decision as to the dot patterns based on values of absolute coordinates of the digital data thus received,
when it is decided the dot patterns represent the box sheet, a code is obtained by conversion based on a range of the absolute coordinates, and is stored in a management table, and
when it is decided the dot patterns represent the document, said digital data is stored in said management table in such a manner as being associated with said code.

10. A data input system according to claim 9, wherein,
a layout of said box sheet and a layout of said document having different dot patterns are stored in a layout definition table in said computer.

11. A data input system according to claim 9, wherein,
a correspondence between said range of the absolute coordinates within said box and said code is stored by dot pattern in a meaning definition table in said computer.

12. A data input system according to claim 9, wherein,
a use purpose of said box sheet with respect to said document is stored in a use purpose definition table in said computer, in such a manner as being associated with each of said dot patterns.

13. A data input system comprising:
an electronic pen for reading a dot pattern on a sheet of paper by a camera when a pen pressure sensor senses a pressure and for converting positional information of the pen tip to digital data by a processor, and
a computer having a CPU for receiving said digital data from said electronic pen via a network, and a storage unit, wherein,
the storage unit of said computer includes,
a layout definition table for holding a layout used by being printed on the sheet, being associated with the dot pattern on the sheet onto which the layout is printed,
a meaning definition table for holding a range of absolute coordinates within a box printed, by dot pattern, on the sheet having the dot pattern, in such a manner as being associated with a meaning,
a use purpose definition table for holding, by dot pattern, a dot pattern to be identified, in such a manner as being associated with a use purpose, and
a management table, which utilizes said meaning as said use purpose and holds said meaning, in such a manner as being associated with digital data of said dot pattern to be identified.

14. A data input system according to claim 13, wherein,
said computer is connected with a display for displaying a layout stored in said layout definition table.

15. A data input system according to claim 14, wherein,
said computer is connected with an input device for selecting the layout displayed on said display.

16. A data input system according to claim 15, wherein,
said computer is connected with a printer for printing the layout thus selected.

17. A document identifying system in a system utilizing a sheet of paper on which a dot pattern is printed, and an electronic pen for reading the dot pattern and digitalizing contents written on said sheet,
wherein,
when it is to be identified in which sheet digitalized data of said contents is written,
a predetermined mark for identification is printed on a sheet with a print of a dot pattern different from that of the sheet to be identified, and
it is identified in which sheet the digitalized data is written, as to said contents written in said sheet to be identified, based on the digitalized data of a check figure entered in a part of said predetermined mark.

18. A document identifying system according to claim 17, wherein,
a box is printed being adjacent to said mark for identification, and the check figure is entered in said box.

19. A document identifying system according to claim 18, wherein,
said mark for identification is entered within said box.

20. A document identifying system according to claim 17, wherein,
a dot pattern on the sheet to be identified and a dot pattern on the sheet onto which said mark for identification is printed are different from each other.
